(19) United States
(12) Patent Application Publication
(10) Pub. No.: US 2002/0142767 A1
(43) Pub. Date: Oct. 3, 2002

(54) Parasitic radio transmission system

(76) Inventors: David F. Mears, Amherst, VA (US); Paul Goodjohn, Lynchburg, VA (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 09/822,064

(22) Filed: Mar. 30, 2001

(51) Int. Cl. H04Q 7/20

(52) U.S. Cl. 455/426; 455/520; 455/11.1

(57) ABSTRACT

A system is disclosed for sending parasitic digital packets over a trunked radio system network during the time that a trunking channel is unoccupied. The parasitic digital packets are received by one or more parasitic receivers, which are not a part of the conventional trunked radio system. To ensure the integrity and reliability of the trunked radio system, the transmission of these parasitic data packets is preempted when the system is required to transmit signals between users of the trunked radio system.

### BACKGROUND OF THE INVENTION

This invention is generally directed to the art of trunked radio systems and more particularly directed to such systems for transmitting digital data over unused radio channels to parasitic receivers that are not part of the conventional trunked system.

A trunked radio system is a two-way voice radio system that allocates a limited number of communication resources, such as radio frequency channels (or time slots in a time division multiplexed system), on a time-shared basis, among a plurality of users throughout a geographical area. The trunked radio system employs one or more repeater sites or base stations for receiving signals from the portable radio of a calling party and re-transmitting the signals to the portable radio of one or more called parties. A portable radio is employed by each system user to communicate with a repeater site and from there with the called parties. The users time-share the radio channels as-needed. Typically, the trunked system includes a number of working channels (each channel including an inbound and an outbound frequency) for communicating between users, and one control channel (also having inbound and outbound frequencies) for setting up the call. A calling party who wants to talk to one or more other users requests allocation of a working channel to carry the call from a central controller. If a communications resource is available, the controller grants the request by assigning a working channel for the call, and then broadcasts a call set-up message on the outbound control channel throughout the coverage area. The outbound control channel is monitored by all users, so the broadcast message advises all trunked radio system users of the working channel assigned to the call. Both the calling party and the called parties detect the working channel assignment and the transmitter of the calling party and the receivers of the called parties are automatically tuned to the assigned working channel. The calling party's voice message is then broadcast over the assigned inbound working channel to the central controller. From there, the message is sent out over the outbound working channel (via a repeater, as needed) to all receiving units on that trunk group, i.e., those receiving units that are assigned to the same call or trunk group as the calling party. Thus, trunking allows radio channels to be pooled so that all users associated with the same trunk channel group have access to the channels assigned to that group. Each portable radio includes a switch, manually operable by the user, for determining the group or groups of users that will receive calls originating from the portable radio.

Most trunked radio systems are licensed to provide service throughout a geographical area on either discrete frequencies or on any frequency within an assigned frequency band. A trunked radio system license usually grants the licensee the right to the exclusive use of these communications resources in the coverage area. Most trunked radio systems allocate pairs of frequency channels. One channel of the pair is used by calling units to transmit (referred to as the inbound working channel) which is monitored by the system controller). The other channel is referred to as the outbound working channel; the called units are tuned to the outbound working channel.

There are many applications for trunked radio repeater systems. One of the most important applications is the public service trunked system. For example, a metropolitan area may advantageously utilize a single system of trunked radios, in conjunction with signal repeaters, to provide efficient radio communications between individual radio units of many different government agencies. Each agency may, in turn, achieve efficient communication between individual units of different fleets or sub units within the agency (e.g., the police department may have a need to provide efficient communications between different units of its squad car force, different portable units assigned to foot patrol officers, different units of detectives, etc.) by the appropriate selection of transmit and receive frequencies. It may also be important, at other times, to communicate simultaneously to pre-defined groups of units (e.g., all units, all the squad cars, all of the foot patrol officers). At the same time, other agencies, such as the fire department, transportation department, etc., may be in need of similar communication services. As is well known to those familiar with trunking systems, a relatively small number of assigned radio frequencies and distributed signal repeaters can efficiently service (i.e., minimizing the number of blocked calls) all of these needs within a given geographic area if they are trunked, i.e., shared on an as-needed basis between all potential users.

The present invention is also adaptable to special mobile radio (SMR) trunked users. In an SMR system, there is provided a trunked radio repeater system at one or more sites within a geographical area. The owner of the system sells air time to various independent businesses or other entities having the need to provide efficient radio communication between individual units or between individual units and a base station. In many respects, the features of an SMR system are similar to those of a public service trunked system.

An exemplary trunked radio repeater system is illustrated in FIG. 1. Typically, the trunked radio repeater system provides voice communication between the calling and the called parties. The voice signals can be carried in analog or digital form on a modulated carrier signal. The system can also carry non-voice digital data by appropriate modulation of a carrier signal. Several groups of users are illustrated, including the police department, emergency/rescue services, public works department, fire department, and transportation department. Individuals within each group can communicate with each other using their portable radios, via a shared radio repeater channel controlled from a trunked repeater site 20. Using a selector switch on the portable radio, each user can select the trunk group with which he wants to communicate. In any given trunked radio system, there will be tens if not hundreds of trunk groups, while the number of trunk groups available to an individual user is far less. For instance, a foot patrol officer 21 can communicate with others within his trunk group, including fellow officers in a police cruiser 22, via the trunked repeater site 20. The foot police officer 21 may also be able to communicate, for instance, with an emergency vehicle 23, by selecting the so-called “emergency group” on his portable radio. In yet another situation, the foot patrol officer 21 can communicate with all users within a police department group 25. Finally, the portable radio may provide an “all-groups” option so that the foot patrol officer 21 can communicate with all groups illustrated in FIG. 1. In one embodiment, the portable radio can be reprogrammed offline to allow user-selectable access to other groups.

A dispatch console 26 communicates with the trunked repeater site 20 for transmitting signals from the dispatcher to one or more members of a group, such as the police department group 25. The dispatch console 26 may be physically located at the trunked repeater site 20 or may be remotely located and therefore use other communications facilities to communicate with the trunked repeater site 20. There may also be multiple dispatch consoles 26, i.e., one for each group illustrated in FIG. 1.

Typically, a trunked radio system for use by emergency and public service organizations is over specified, i.e., the number of channels designed in the system is significantly greater than the expected number of simultaneous users. In this way, the system designer can ensure that no calls for service are blocked because a free channel is not available. Conversely, because the system is over specified and the usage tends to be intermittent and each use generally of a short duration, there is considerable time when the channels are unused. But it would be imprudent to completely remove one or more channels from service as this would decrease the system capacity and increase the probability of a blocked call during periods of high usage.

It is known to use a cellular system for the transmission of digital data during those times when system frequency resources are not used. Essentially, a cellular telephone call is established by conventional means, but in lieu of transmitting voice information, the channel is captured by digital transmitting and receiving devices. Digital data is then streamed over the cellular channel and frequency hand-offs occur as the user moves from one cell to another, in the same manner as cell call hand-offs that occur during a voice call. This system, referred to as cellular digital packet data, was created to take advantage of idle communications resources in the cellular system. The digital data carried by such a system is available only to regular system users and additionally the data is formatted in the same manner as voice call information for carriage by the cellular telephone system in accordance with system standards and protocols.

### BRIEF SUMMARY OF THE INVENTION

The present invention overcomes the limitations of the prior art by providing a communications system to utilize the resources of a trunked radio system (or cellular telephone system) when not otherwise being utilized in the conventional manner for which the system was designed, i.e., providing voice calls between a calling party and a called party. The present invention adds a digital data transmission service to an existing system, for instance a trunked radio system, without interfering with the normal operation of the trunked radio system. In one embodiment, the digital data transmission service is intended for low data-rate, packetized data to be received by simple, low cost fixed frequency receivers. The teachings of the present invention can also be applied to add a data overlay feature to any broadcast system, including a paging system, as will be discussed below. The digital data is referred to herein as parasitic digital data, or overlay digital data since it is transmitted only on a secondary or overlay basis when the system is not otherwise in use.

The functionality offered by the present invention adds a digital data overlay transmission capability to a group of users who are not a part of the communications system, i.e., parasitic users, when the system is not otherwise being utilized for its originally intended purpose. In one embodiment, the parasitic digital data is packetized, with each packet containing the address of the intended receiver. In another embodiment the parasitic digital data is broadcast to all receivers with the intended receiver or receivers operating on the received parasitic digital data. For example, in an embodiment associated with a trunked radio system, parasitic users can receive parasitic digital data via the trunked radio system network during those intervals when the network is not in use carrying trunked radio signals, generally voice signals. The parasitic data is provided to the parasitic users utilizing the trunked system transmitters on a secondary basis, i.e., normal transmissions over the trunked radio system have priority. Advantageously, modifications to an existing trunked radio system to add the capabilities offered by the present invention are minimal. Studies indicate that the average call duration on a trunked radio system is 3.2 seconds. Thus, there is significant time available for operation in the parasitic mode.

The trunked radio system users will generally not be aware of the parasitic digital data transmissions as the two systems operate nearly independently.

No sophisticated modifications are required to an existing trunked radio system for implementation of the system of the present invention. The only nexus between an existing trunked radio system and a digital data overlay transmission system in accordance with the present invention is the use of the power amplifier on/off control in the repeater or base station to gate the digital data overlay transmissions. When the power amplifier at the base station or repeater site is on, then the frequency associated with that power amplifier is not available for use by the digital data overlay system. Conversely, if the power amplifier is off, then that frequency is available for transmitting parasitic data. In another embodiment of the present invention, rather than monitoring each power amplifier, the digital data overlay system monitors the channel assignment controller for the trunked radio repeater system. The controller assigns the inbound and outbound frequencies as requested by users, and thus monitoring of these frequency assignments allows the determination of unoccupied frequency slots for use in transmitting and receiving parasitic digital data. In one embodiment, each parasitic data receiver is fixed tuned to a specific channel frequency employed by the trunked radio system, and thus can receive signals via the digital data overlay system only when they are broadcast on that frequency. In another embodiment, all the parasitic receivers scan all the trunked radio channels in search of packetized parasitic digital data bearing an address of the scanning unit. In yet another embodiment the packetized parasitic digital data is broadcast to all parasitic receivers, but only the intended receivers operate on the received data. The intended receiver can be determined by a header prefacing the information portion of the parasitic digital words.

### BRIEF DESCRIPTION OF THE DRAWINGS

The present invention can be more easily understood and the further advantages and uses thereof more readily apparent, when considered in view of the following description of the preferred embodiments and the following figures in which:

FIG. 1 is a block diagram of a prior art trunked radio system;

FIG. 2 is a block diagram of the present invention incorporated into a trunked radio system;

FIGS. 3 and 4 illustrate signals on the working and control channels in conjunction with the teachings of the present invention; and

FIG. 5 is a block diagram showing the digital data generator of the present invention incorporated into a trunked radio transmission system.

### DETAILED DESCRIPTION OF THE PREFERRED EMBODIMENTS

Before describing in detail the particular method and apparatus for providing digital data communications over a trunked radio system, it should be observed that the present invention resides primarily in a novel combination of steps and apparatus related thereto. Accordingly, the hardware components and method steps have been represented by conventional elements in the drawings, showing only those specific details that are pertinent to the present invention, so as not to obscure the disclosure with structural details that will be readily apparent to those skilled in the art having the benefit of the description herein.

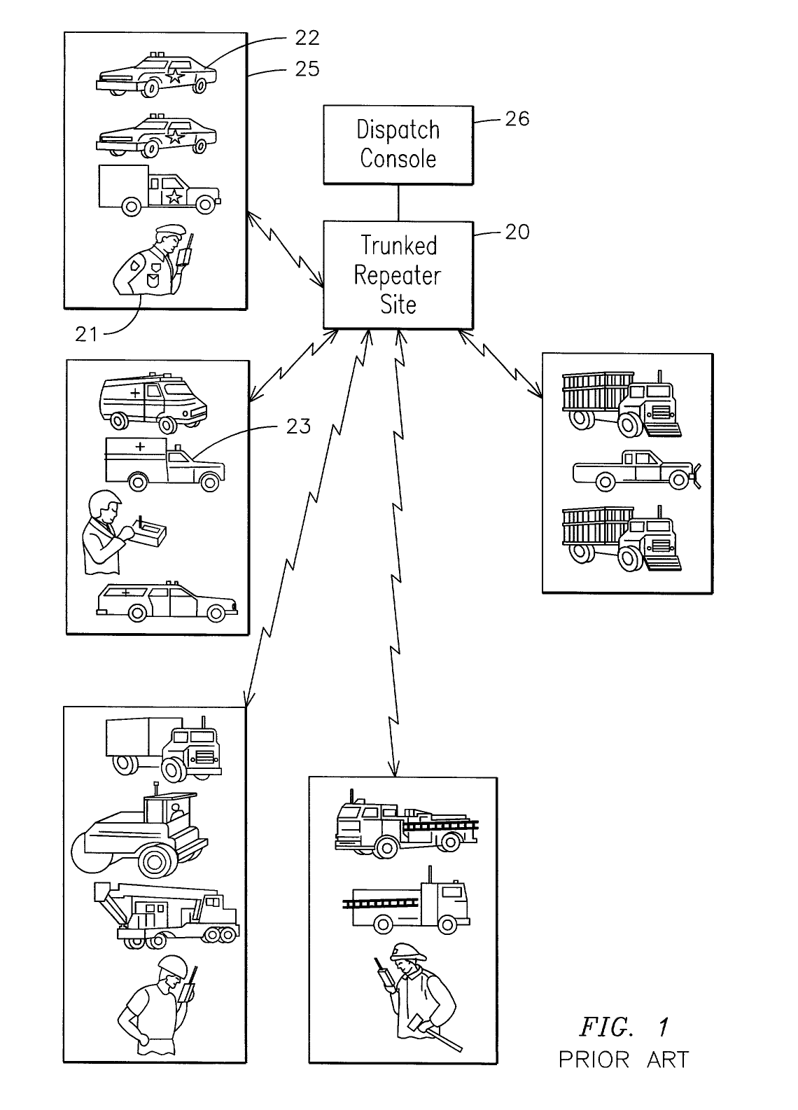

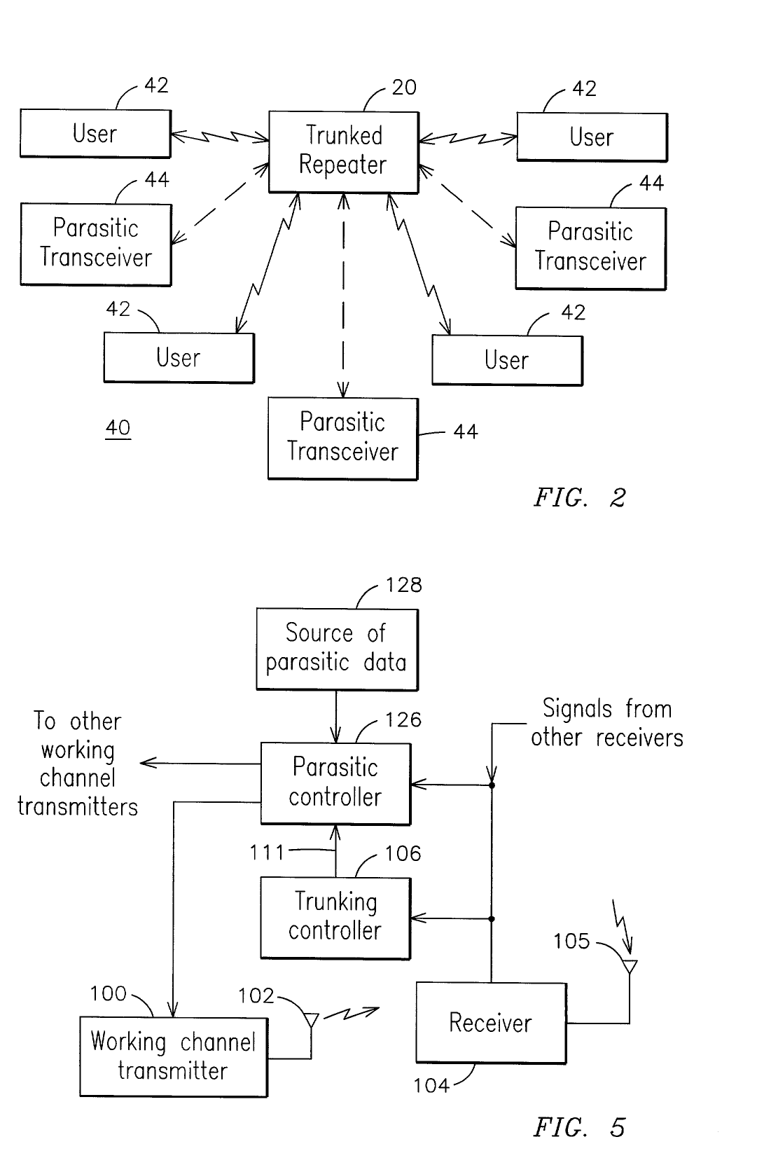

FIG. 2 is a block diagram of a trunked radio system 40 constructed according to the teachings of the present invention. Like the prior art trunked radio system illustrated in FIG. 1, the trunked radio system 40 includes a trunked repeater 20 for communicating with a plurality of users 42 over an assigned working channel, comprising an inbound frequency and an outbound frequency. The users 42 receive signals from and send signals to the trunked repeater 20 as in the prior art. Typically, the signals are voice communications from the calling unit to the called unit or units. Additionally, the trunked radio system 40 includes one or more parasitic transceivers 44. In one embodiment, each parasitic transceiver 44 is fixed-tuned to an outbound working frequency, and can therefore receive a signal from the trunked repeater 20 only on that outbound frequency when it is available, i.e., not in use by the trunked radio system. Controllers (to be discussed in detail later) at the trunked repeater 20 control the transmission of the parasitic digital data to the parasitic transceivers 44 when one or more trunked radio frequency channels are not in use. Generally, the parasitic digital data is packetized and transmitted at a low data rate, given the relatively narrow bandwidth of the trunked channel frequencies, because they are typically used for voice communications. Since there is no way to predict the availability of a specific outbound channel or, in fact, the availability of any outbound channel, the parasitic digital data transmitted to the parasitic transceivers 44 is typically not high priority data. For example, electricity usage information as measured by a watt-hour meter can be transmitted from the meter to the billing site whenever a working channel is available. Such information is not generally considered high priority data. Given these system limitations, it generally would not be advantageous to rely on the present invention for the transmission of digital information that must be immediately available at the receiving site. Other possible applications for the parasitic transceivers include remote telemetry, paging, differential GPS correction data, and news and stock market information. Slowly changing digital data and repeatable strings of digital data are also good candidates for the relatively narrow bandwidth and secondary usage system of the present invention.

In lieu of using fixed-tuned receiving parasitic transceivers, according to another embodiment of the present invention, each parasitic transceiver 44 can scan the available frequencies until a parasitic digital data signal is encountered. By reading the data header, the receiving parasitic transceiver can determine if the parasitic digital data is intended for that parasitic transceiver.

An exemplary trunked radio system, such as the EDACS system available from ComNet Ericsson of Lynchburg, Virginia, comprises a trunked repeater site and a plurality of portable radios operative over a plurality of radio channels. Each channel comprises an inbound and an outbound frequency over which a communications link is established between the trunked repeater 20 and the users 42. One channel, designated the control channel, carries control messages transmitted continuously from the trunked repeater 20 to the users 42, for instance public service users, for setting up and tearing down each call. The remaining channels of the trunked radio system 40 are working or traffic channels for carrying inbound and outbound signals.

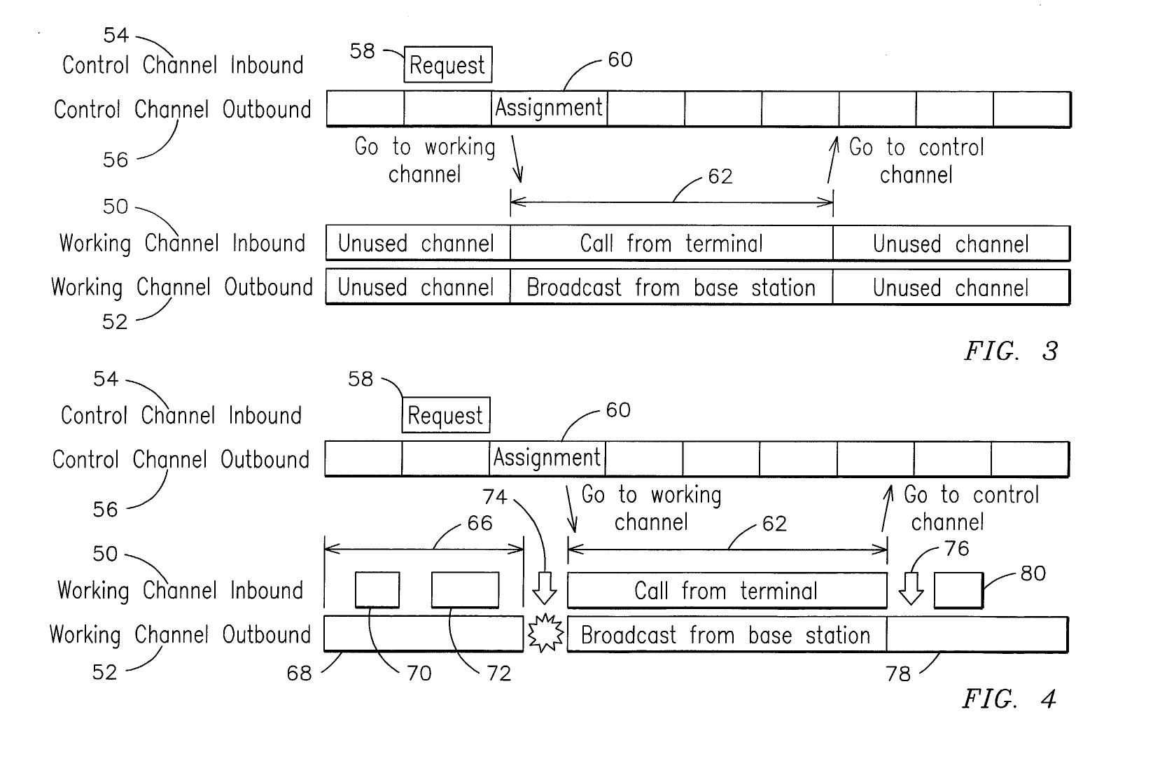

Referring to FIG. 3, there is shown an inbound working channel 50, an outbound working channel 52, an inbound control channel 54, and an outbound control channel 56. In one embodiment of the trunked radio system 40, there are 23 inbound/outbound working channel frequency pairs and a single inbound/outbound control channel frequency pair. Thus, the working channel inbound and outbound pair 50/52 represents one of the 23 different channel frequency pairs. When a user 42 wishes to make a call on the trunked radio system 40, a request signal 58 is sent from the user's portable radio to the trunked repeater site 20 over the inbound control channel 54. Control circuitry, which is well known in the art, at the trunk repeater site 20 selects an available working channel and advises the sending and receiving users of the assigned working channel on which the signals are to be transmitted and received. This frequency assignment is illustrated by a reference character 60. In addition to the assigned frequencies for the call, the assignment information can also include the type of modulation for the signal and whether the signals are to be encrypted. In short, the assignment information includes everything that the called units and the calling unit require for properly sending/receiving the signal.

When the transmitting and receiving users 42 receive the channel assignment information on the outbound control channel 56, the transmitting portable radio automatically tunes to the assigned inbound working channel 50 and the receiving portable radios in the called trunk group automatically tune to the outbound working channel 52. Thereafter, during a time period 62, the inbound and outbound channels are busy, carrying the inbound and outbound voice transmissions. Specifically, during the time period 62, the inbound working channel 50 carries the signal from the calling user to the trunked repeater site 20, for broadcast to the called parties on the outbound working channel 52. In one embodiment, the geographical area served by the trunked radio system 40 includes a plurality of trunked repeater sites 20 so as to provide coverage for the entire area. In this embodiment, it may be necessary to transmit signals between trunked repeaters 20 so that all intended users within the coverage area can receive the outbound signal. One of the repeaters 20 may serve as the base station for the trunked radio system 40.

Once the transmissions have ended, both the calling and called portable radios return to the frequency of the outbound control channel 56, for monitoring the control channel in anticipation of another channel assignment. Therefore, at the end of the time period represented by the reference character 62, both the working inbound channel 50 and the working outbound channel 52 are unused. It is during this time, in accordance with the teachings of the present invention, that parasitic digital data is transmitted on the working outbound channel 52 to the parasitic transceivers 44. Since cellular radio systems employ channel assignment schemes similar to the scheme illustrated in FIG. 3, the teachings of the present invention can also be applied to cellular radio systems.

In accordance with the teachings of the present invention, the inbound and outbound working channels 50 and 52 carry parasitic digital data (or analog signals) to and from the parasitic transceivers 44 when not in use by the trunked radio system 40. (The transmitting mode for the parasitic transceivers 44 is discussed below.) For example, during a time interval 66 shown in FIG. 4, the outbound working channel 52 carries a parasitic data packet 68, which is received by the parasitic transceivers 44 tuned to the frequency of the outbound working channel 52. In the system configuration where the parasitic digital data is intended for only a single parasitic transceiver 44, the other parasitic transceivers 44 simply ignore the received data when the address header does not match the address of the receiving parasitic transceiver 44. For example, one of the parasitic transceivers 44 can receive news ticker information, while another transmits and receives remote control telemetry data from an electrical power substation. The news ticker information is provided to the repeater 20 by a news gathering or publishing organization. The control telemetry is provided to the repeater 20 from a communications link to the substation. The parasitic receiver can be located at the supervisory center for the electrical grid. In another configuration, the parasitic digital data signal is broadcast to all or several parasitic transceivers 44 and all process the received digital data signal. This configuration may be used, for example, to broadcast traffic alerts to a plurality of parasitic transceivers 44 spaced at intervals along a major highway. The parasitic digital data is processed to control the message on a highway message signboard colocated with each parasitic transceiver 44.

In lieu of using fixed-frequency receivers, the parasitic transceivers 44 can scan the outbound working channels until a parasitic signal intended for the receiving transceiver is located. It is also possible, in this embodiment, to allocate selected inbound/outbound frequency pairs to a specific area of the geographic region serviced by the trunked radio system. In this way, the parasitic transceivers 44 are required to scan only those frequencies allocated to the area in which they are located.

The parasitic transceivers 44 can also transmit parasitic digital data packets back to the trunked repeater site 20 on an inbound frequency channel, as governed by channel assignment information within the outbound data packet or in response to a channel assignment signal on the outbound control channel. From the receiving trunked repeater site 20, the incoming signals from the parasitic transceivers 44 can be routed to the intended recipient, for instance, via the public switched telephone network, via the Internet using Internet protocol, or via a point-to-point or point-to-multi-point transmission system.

For a specific example of the inbound channel assignment process, reference is made to FIG. 4, where parasitic data packets 70 and 72, occurring within the time interval 66, are sent over the inbound working channel 50. In one embodiment, the assignment of an inbound working channel to a parasitic transceiver 44 for the transmission of parasitic digital data is based on the transmission of parasitic digital data on the outbound working channel. Since the channel assignments are made in pairs, clearly if the outbound working channel is in use to transmit parasitic digital data, then the paired inbound working channel is available for parasitic data transmission from a parasitic receiver 44 to the trunked repeater site 20. In another embodiment where the assignment of trunk channels (frequency pairs) and digital data channels is closely coupled, inbound and outbound channels can be assigned independently and strictly on an as-available basis, without regard to the pairing of channels for a single use.

Continuing with FIG. 4, during the interval 66 when the parasitic transceivers 44 are using the inbound and outbound working channels 50 and 52, a request 58 from a user 42 appears on the inbound control channel 54. A working channel assignment 60 is made (i.e., inbound and outbound frequencies are assigned) and the call set-up information is carried on the outbound control channel 56. Once the assignment information reaches the calling and called users, at a time indicated by an arrowhead 74, parasitic data transmission is interrupted and the users take control of both the inbound and outbound working channels 50 and 52 for transmitting and receiving signals as discussed in conjunction with FIG. 3. During the subsequent interval 62, the signal from the calling party is carried on the inbound working channel 50, and the outbound channel 52 carries the signal to the called parties. When the calling party's transmission begins, the system controller (to be discussed further below) determines that the digital data transmission was interrupted and holds the parasitic digital data for a later transmission retry when a channel becomes available.

In another embodiment, the end of each transmission to a parasitic receiver 44 can generate an acknowledgement signal back to the trunked repeater site 20. If the acknowledgement is not received, then the system controller must resend the parasitic digital data when a channel becomes available.

At a time indicated by an arrowhead 76, the users 42 have completed transmissions on the inbound and outbound working channels 50 and 52 and these channels are released, that is they are again free for transmitting and receiving parasitic digital data from the parasitic transceivers 44. A parasitic digital data packet 78, carried on the outbound working channel 52, can represent the retransmission of the signal interrupted at the arrowhead 78. A parasitic digital data packet 80 is also transmitted on the inbound working channel 50, as shown.

In one embodiment of the present invention, in the normal course of operation, each of the parasitic digital data packets 68 can be automatically re-sent to provide system redundancy. Each packet can also include error correcting information for use at the parasitic receiver 44 to detect and correct errors in the received packet.

The data stream comprising each parasitic digital data packet, such as the parasitic digital data packets 78 and 80, may convey information in addition to payload data. This information can include, for example, the channel number of other related parasitic packet channels. Also, outbound parasitic data packets may identify the availability of the inbound working channel 50, since the parasitic transceivers lack the ability to identify usable inbound working channels.

The type of modulation used for the parasitic digital data packets does not necessarily have to be the same as the modulation used for carrying the voice signals between users. However, there is an advantage to using the same modulation type as it is then not necessary to switch the transmitter on and off as the system switches between carrying voice signals and carrying the parasitic data, thereby reducing switching transients and the interference they cause. Also, the radio system data transmissions are masked as the inbound and outbound working channels 50 and 52 are continuously occupied such that an eavesdropping listener cannot distinguish the parasitic data from the conventional transmissions. Additionally, use of the existing radio system hardware for transmitting the parasitic digital data packets avoids the costs of acquiring additional hardware and extends the life of existing hardware due to a reduction in the number of on/off cycles.

FIG. 5 is a block diagram showing the principal components of the trunked repeater 20. A working channel transmitter 100 transmits via an antenna 102 either a trunked radio signal to one or more of the users 42 or a parasitic digital packetized data signal to one or more of the parasitic transceivers 44. The working channel transmitter 100 is continuously powered so that either trunked signals or parasitic data can be sent therefrom on the outbound working channel 52. The trunked repeater site includes a number of transmitters and receivers equal to the number of working channels, where each transmitter and receiver is tuned to its assigned working channel outbound/inbound frequency. The repeater site also includes a transmitter and receiver for the outbound/inbound control channel. The repeater site further includes a plurality of antennas, one for each receiver/transmitter. The radio frequency signals can also be combined in a conventional RF combiner, thereby requiring fewer antennas at the site.

The voice signal for transmission over the trunked radio system 40 is received from a calling user at a receiver, such as a receiver 104, tuned to the frequency of the assigned inbound working channel, via an antenna 105. The received signal is input to a trunking controller 106, where an outbound working channel is assigned for carrying the outbound signal. Typically, the channels are assigned in pairs, i.e., an inbound working channel is paired with an outbound working channel. The received signal is also input to a parasitic controller 126. The identification of the assigned working channel is communicated from the trunking controller 106 to the parasitic controller 126 over a control line 111. The parasitic controller 126 recognizes this assigned outbound working channel has end use by the trunk radio system and therefore not available for transmitting or receiving parasitic digital data. In essence, the control signal from the trunking controller dates off the parasitic controller 126 for the assigned outbound working channel. Also, the control information allows the parasitic controller 126 to input to the received signal to the appropriate working channel transmitter (i.e., the working channel transmitter tuned to the assigned outbound frequency), such as the working channel transmitter 100. Finally, the signal is transmitted via the antenna 102 to the called users. In the event that the parasitic controller 126 was transmitting parasitic digital data when the trunking controller assigned the outbound frequency to a user's call, the parasitic controller 126 detects this assignment via the control line 111 and in response pauses the parasitic data stream, i.e., either aborts the transmission or stores the parasitic digital data for later transmission.

In one embodiment, the parasitic controller 126 holds the data in memory until it is assured that the parasitic data has successfully reached the destination parasitic receiver 44. This can be accomplished by the transmission of an acknowledgement signal from the destination parasitic receiver 44 or simply the passage of a predetermined period of time and the absence of a resend command from the intended parasitic receiver 44.

When the trunking controller 106 releases an outbound working channel, the parasitic controller 126 detects this action via a signal on the central line 111, and the free frequency is now available to transmit parasitic digital data packets received from a digital data source 128, under control of the parasitic controller 128. In another embodiment where the trunking controller 106 and the parasitic controller 126 are not coupled, a monitor can be employed for detecting available working channels. Those skilled in the art will recognize that there are many different types of parasitic digital data that can be transmitted. For instance, one of the parasitic receivers 44 can be located at a bus stop and the parasitic digital information sent thereto can take the form of bus time-of-arrival information originating from a bus dispatcher. Weather related information can be broadcast to a plurality of parasitic receivers 44. Also, traffic congestion information can be provided to a roadway information sign colocated with a parasitic receiver 44.

While generally the parasitic digital packetized data size can be of any length, there is one important limitation to avoid impairment of normal operation of the trunking radio system. At the beginning of each call carried by the inbound or outbound working channels 50 and 52, there is a synchronization period. The synchronization header is sent from the calling portable radio, followed by a blanking interval, and then followed by a return synchronization signal from the called portable radio. The digital packetized data must have a length shorter than the blanking interval between these two synchronization signals. If the digital packetized data signal is longer than the blanking interval, the packet can interfere with the return synchronization signal and thereby prevent transmission of the voice signal from the trunked repeater site 20 to its intended user. Further, it is generally known that statistically, shorter packet lengths have a lower probability of being interrupted by a voice call on the trunked radio system.

The teachings of the present invention can be applied to any communication system that is not in continuous use (i.e., some frequencies are available intermittently), such that the system can operate in an overlay or parasitic mode, thereby providing dual use of the base system. In particular, a trunked system is a good candidate due to its multiple channel configuration and intermittent, short duration usage. The present invention can also be applied to a paging system, which is similar in architecture to the trunked radio system 40, with the exception that a paging system is unidirectional, that is, all signals travel only in the outbound direction. Individual pages, which include a header identifying the receiving unit to which the page is directed, are broadcast over the paging system in the conventional manner. Typically, all queued pages are broadcast every second. In accordance with the teachings of the present invention, the paging system is augmented by a plurality of parasitic receivers for receiving parasitic digital information during the time intervals between pages. Each of the digital parasitic data packets broadcast by the system includes an address header identifying the parasitic transceiver or transceivers for which the packet is intended.

In another embodiment, the base station 20 is configured to assign working channels using any one of a number of known techniques, for instance, random assignments or sequential assignments. One method forces the trunking controller 106 to always assign the lowest numbered available working channel. Thus, the assigned working channels tend to be those with the lowest channel number. The higher channels are typically assigned only under heavy loads. A similar assignment scheme can be employed for the parasitic digital data channels, giving the higher numbered channels the highest priority. In this embodiment, the trunking channels are interrupted only when the trunking system is heavily loaded, as the highest priority traffic of both types are at opposite ends of the working channel map.

Generally, the system according to the present invention causes minimal interference to the trunking system because the trunking system is accorded a higher priority. In another embodiment where the trunking controller 106 and the parasitic controller 126 are tightly coupled, it is possible to coordinate channel assignments. This configuration minimizes interruption of the parasitic digital data transmissions because the trunking controller 106 is aware of the channels in use by the digital data overlay transmission system and avoids assigning them unless the trunking system is heavily loaded and the channels are required by the higher priority trunked signals.

In yet another embodiment, it is possible to improve certain timing parameters to improve operation of the digital data overlay transmission system while causing only slight degradation to trunked operation. Thus transmission of the trunked signal is delayed until transmission of the digital data message is complete (in contrast to simply pausing or interrupting the parasitic digital data transmission). This feature may add approximately 100 to 250 milliseconds to the trunking channel access time, which may not be problematic in certain trunking applications.

While the invention has been described with reference to a preferred embodiment, it will be understood by those skilled in the art that various changes may be made and equivalent elements may be substituted for elements thereof without departing from the scope of the present invention. In addition, modifications may be made to adapt a particular situation more material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A communications system for transmitting information signals to a first plurality of receivers upon request, and for transmitting parasitic data to a second plurality of receivers, said communications system comprising:
a transmitter for transmitting an information signal to at least one of the first plurality of receivers on an assigned frequency selected from among a plurality of available frequencies, in response to a request to transmit received from a user of said communications system; and
said transmitter for transmitting parasitic data to at least one of the second plurality of receivers on a heretofore unoccupied frequency selected from among the plurality of available frequencies, and wherein the parasitic data transmission is interrupted if the selected frequency is required for transmitting an information signal to one of the first plurality of receivers.

2. The communications system of claim 1 wherein the parasitic data is transmitted in the form of digital data packets.

3. The communications system of claim 1 comprising a trunking system, wherein each of the first plurality of receivers includes a transmitting apparatus, and wherein a user of one of the first plurality of receivers requests a frequency assignment over which the information signal is transmitted from the requesting user to at least one other of the first plurality of receivers.

4. The communications system of claim 3 wherein the users of the first plurality of receivers provide public services.

5. A trunked radio repeater system including a trunked radio repeater and a plurality of portable radios for communicating bi-directionally with each other via said trunked radio repeater, wherein the trunked radio repeater system further includes plural working channels, said trunked radio repeater system further including a plurality of parasitic receivers operating on a secondary basis to the plurality of portable radios, said trunked radio repeater system comprising:
a first controller for receiving a request from one of the plurality of portable radios to transmit an information signal to at least one other of the plurality of portable radios, and in response thereto for assigning a working channel to carry the information signal; and
a second controller responsive to said first controller for transmitting parasitic data to one or more of the plurality of parasitic receivers on an unoccupied working channel.

6. The trunked radio repeater system of claim 5 wherein the working channel includes an inbound frequency for carrying the information signal inbound from the requesting portable radio to the trunked radio repeater, and includes an outbound frequency for carrying the information signal from the trunked radio repeater to one or more of the plurality of portable radios.

7. The trunked radio repeater system of claim 5 including an inbound and an outbound control channel, wherein the request to transmit is carried over said inbound control channel and wherein the first controller transmits a signal to at least one of the plurality of portable radios on said outbound control channel, and wherein said signal identifies the working channel for carrying the information signal.

8. The trunked radio repeater system of claim 5 wherein each one of the plurality of parasitic receivers includes a transmitter for transmitting a parasitic signal to the trunked radio repeater.

9. The trunked radio repeater system of claim 8 wherein a signal is transmitted from the trunked radio repeater to at least one of the plurality of parasitic receivers, wherein said signal assigns a working channel on which the parasitic receiver can transmit to the trunked radio repeater.

10. The trunked radio repeater system of claim 9, including an outbound control channel for carrying the signal assigning the working channel assignment.

11. The trunked radio repeater system of claim 9 wherein each working channel includes an inbound frequency and an outbound frequency, and wherein the inbound frequency to be used for transmitting to the trunked radio repeater from one of the plurality of parasitic receivers is the inbound frequency of the working channel on which the parasitic receiver last received parasitic data.

12. The trunked radio repeater system of claim 5 wherein the second controller transmits an outbound frequency assignment signal to at least one of the plurality of parasitic receivers, in response to which the at least one parasitic receiver tunes to the assigned outbound frequency and thereafter receives the parasitic data on the assigned outbound frequency.

13. The trunked radio repeater system of claim 5 wherein the parasitic data includes address information, wherein each one of the plurality of parasitic receivers has an address, wherein the parasitic data is transmitted to all of the plurality of parasitic receivers, but only the parasitic receiver having an address matching the address information in the parasitic data responds to the parasitic data.

14. The trunked radio repeater system of claim 5 wherein the parasitic data is transmitted in the form of digital data packets.

15. The trunked radio repeater system of claim 5 wherein the parasitic data is broadcast to all of the plurality of parasitic receivers on a predetermined channel, and wherein the parasitic data includes a header portion identifying the one or more of the plurality of parasitic receivers for which the parasitic data is intended.

16. The trunked radio repeater system of claim 5 wherein each one of the plurality of parasitic receivers scans the working channels searching for parasitic data.

17. The trunked radio repeater system of claim 5 wherein when the first controller assigns a working channel that is in use transmitting parasitic data, the parasitic data transmission is terminated and the working channel is relinquished for transmitting an information signal.

18. The trunked radio repeater system of claim 17 wherein the termination of the parasitic data transmission before completion thereof causes the parasitic data to be stored and transmitted at a later time.

19. A method for operating a trunked radio repeater system having a control channel and plural working channels, wherein the working channels are assigned for use by one or more of a first plurality of radios as specified by a control signal carried on the control channel and assigned for use by a second plurality of radios when not in use by one of the first plurality of radios, said method comprising:
operating one or more of the first plurality of radios on one of the plural working channels in response to an assignment signal carried on the control channel;
determining when a working channel is unoccupied; and
operating one or more of the second plurality of radios on an unoccupied working channel.

20. The method of claim 19 wherein when one of the second plurality of radios is operating on a working channel and it is determined that the working channel is required by one of the first plurality of radios, terminating use of the working channel by the one of the second plurality of radios.

21. The method of claim 19 wherein operation of the second plurality of radios includes receiving parasitic data.

22. The method of claim 21 wherein in response to termination of the working channel by the one of the second plurality of radios, the information is being transmitted thereby retransmitted at a later time.
